(19) United States
(12) Patent Application Publication
(10) Pub. No.: US 2002/0184334 A1
(43) Pub. Date: Dec. 5, 2002

(54) System and method for providing intelligence to network devices

(76) Inventors: Darrel D. Cherry, Meridian, ID (US); Garth F. Schmeling, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/873,822

(22) Filed: Jun. 4, 2001

(51) Int. Cl. H04N 7/14; G06F 15/16

(52) U.S. Cl. 709/217; 348/14.03

(57) ABSTRACT

A system and method are disclosed which enable devices communicatively coupled to a communication network to each have a relational context that specifies how such device relates to other devices within the communication network. For example, a device may include a relational context that specifies how its operational capabilities measure up to the operational capabilities of other devices within the communication network. In one embodiment, a server is communicatively coupled to a communication network, and aggregate context information specifying operational parameters available via the communication network is communicatively accessible by the server. A network device is communicatively coupled to the communication network and includes operational specification information specifying individual operational parameters thereof stored locally thereto. The device further includes relational context information stored locally thereto, which specifies the relation of its individual operational parameters to the aggregate of operational parameters available via the communication network.

### TECHNICAL FIELD

This invention relates in general to devices communicatively coupled to a communication network, and in specific to such devices implemented with intelligence as to how their operational capabilities relate (e.g., how they compare) to other devices within the communication network.

### BACKGROUND

Communication networks are commonly implemented to communicatively interconnect various types of devices. For example, personal computers (PCs), printers, optical scanners, fax machines, data storage devices, and many other types of devices are commonly coupled to a communication network, such as a general purpose processor-based information network, public switched telephone network (PSTN), wireless network, local area network (LAN), wide area network (WAN), modem to modem connection, the Internet, an Intranet, an Extranet, or any combination thereof, as examples.

Devices commonly include information defining their operational capabilities. That is, devices typically have their operational specification stored locally thereto (e.g., stored internally). As an example, a printer may include its operational specification, which may provide information about its operational capabilities, such as its print speed, its print resolution, etcetera. Oftentimes a user or software application desires to utilize a network device having particular operational capabilities. For example, a software application executing on a processor-based device (e.g., a PC, laptop, etc.) that is communicatively coupled to a communication network may desire to utilize a printer on the network that provides the best print resolution. Given the dynamic nature of typical communication networks, the device desired to be utilized by an application may change over time (e.g., the printer that provides the best print resolution may change over time). For instance, devices are commonly added to the network, removed from the network, and/or have their operational capabilities upgraded, thereby altering the network's topology and/or operational capabilities.

Accordingly, a software application may query the network devices for their operational specifications, and utilize such operational specifications to determine the device(s) having the operational capabilities desired. That is, a software application executing on a processor-based device that is communicatively coupled to the network may query each device on the network for information from its operational specification, and then filter through the information utilizing parameter(s) in which the software application is interested to determine the most appropriate device to utilize. Continuing with the above example wherein a software application desires to utilize a printer that provides the best print resolution available via the network, the software application may query all of the printers on the network for their operational specifications. The software application may then filter through the received operational specifications to determine the printer(s) having the best print resolution (as well as any other operational parameters desired). Once the software application determines the printer that satisfies the desired operational parameter (e.g., has the best print resolution), the software application may direct a print job to such printer. Of course, while the example of a printer has been used above, it should be understood that various other types of devices coupled to a network typically have their operational specification stored locally. That is, devices typically have information stored local thereto specifying their individual operational capabilities.

### SUMMARY OF THE INVENTION

In view of the above, devices typically have information specifying their individual operational capabilities stored local thereto. However, individual devices of the prior art have no concept as to how they relate to other devices within a communication network. For example, individual devices have no information specifying how their own operational parameters measure up to the operational capabilities of other devices within the communication network. Thus, in the above example wherein a software application desires to utilize a printer having the best print resolution, each printer coupled to the network has no concept of whether it provides the best resolution of the printers available via the communication network. Rather, each printer has stored local thereto its own operational capabilities, without understanding how those operational capabilities relate (e.g., measure up) to the operational capabilities of other printers within the network.

Therefore, as described above, the prior art typically requires that the software application query each device for its operational specification and then filter through the received operational specifications evaluating particular parameters of interest (e.g., print resolution) to determine the device(s) having the desired operational capability. This prior art technique is problematic in that it requires an undesirably long time to identify device(s) having the operational capabilities desired, requires an undesirably large amount of processing power for the software application to filter through the received operational specifications to identify appropriate device(s), and results in an undesirably large amount of traffic across the communication network (e.g., traffic is created with the software application querying each device, and further traffic is created in each device responding to the software application with its individual operational specification).

The present invention is directed to a system and method which enable devices communicatively coupled to a communication network to each have a relational context that specifies how such device relates to other devices within the communication network. For example, in at least one embodiment, a device includes a relational context that specifies how its operational capabilities measure up to the operational capabilities of other devices within the communication network.

According to at least one embodiment, a system and method are disclosed in which a server is communicatively coupled to a communication network. Additionally, aggregate context information specifying operational parameters available via the communication network is provided such that it is communicatively accessible by the server. At least one device, such as a printer, is communicatively coupled to the communication network, and the device includes operational specification information specifying individual operational parameters thereof stored locally to such device. Also, the device further includes relational context information stored locally thereto, which specifies the relation of the individual operational parameters of the device to the aggregate of operational parameters available via the communication network.

In one embodiment, the aggregate context information includes information specifying an aggregate of operational parameters available via a totality of devices communicatively coupled to the communication network. In another embodiment, the aggregate context information may include information specifying an aggregate of operational parameters available via a totality of devices of a particular type communicatively coupled to the communication network. Such aggregate context information may includes information specifying one or more ranges of operational parameters available via devices coupled to the communication network.

In at least one embodiment, the relational context information includes information comparing one or more of the individual operational parameters of a device to like operational parameters of other devices coupled to the communication network. According to at least one embodiment, the device includes a software application executable thereon to receive at least a portion of the aggregate context information from the server and map one or more of the device's individual operational parameters onto the received aggregate context information to generate the relational context information. In certain embodiments, the server includes a software application executable thereon to map the aggregate context information into relational categories, such as “high,” “medium,” and “low.” Thus, such relational categories may include different categories for different values of an operational parameter. For instance, print resolution of 75 dpi for a particular printer may be mapped to “low” resolution, while print resolution of 1200 dpi for another printer may be mapped to “high” resolution.

In at least one embodiment, the device coupled to the communication network includes a software application executable thereon to communicate its operational specification information to the server. Additionally, the server may include a software application executable thereon to receive the operational specification information from a device and update the aggregate context information to reflect the operational specification information. Thereafter, updated aggregate context information may be communicated to the relevant devices so that they can update their respective relational contexts. In this manner, various network devices may dynamically maintain intelligence regarding how their respective operational parameters relate to the operational parameters of other network devices coupled to the communication network.

### BRIEF DESCRIPTION OF THE DRAWING

FIG. 1 shows an exemplary environment in which various embodiments of the present invention may be implemented;

FIG. 2A shows an example of a printer coupled to a communication network, wherein such printer includes intelligence in the form of a relational context that specifies how its operational capabilities relate to those of other printers available via the communication network;

FIG. 2B shows a further example in which a second printer is coupled to the communication network in addition to the printer of FIG. 2A, wherein each of the printers include intelligence in the form of relational contexts that specify how their respective operational capabilities relate to those of other printers available via the communication network; and

FIG. 3 shows an exemplary operational flow diagram that shows the operational flow for maintaining relational contexts for devices within a dynamic network according to one embodiment of the present invention.

### DETAILED DESCRIPTION

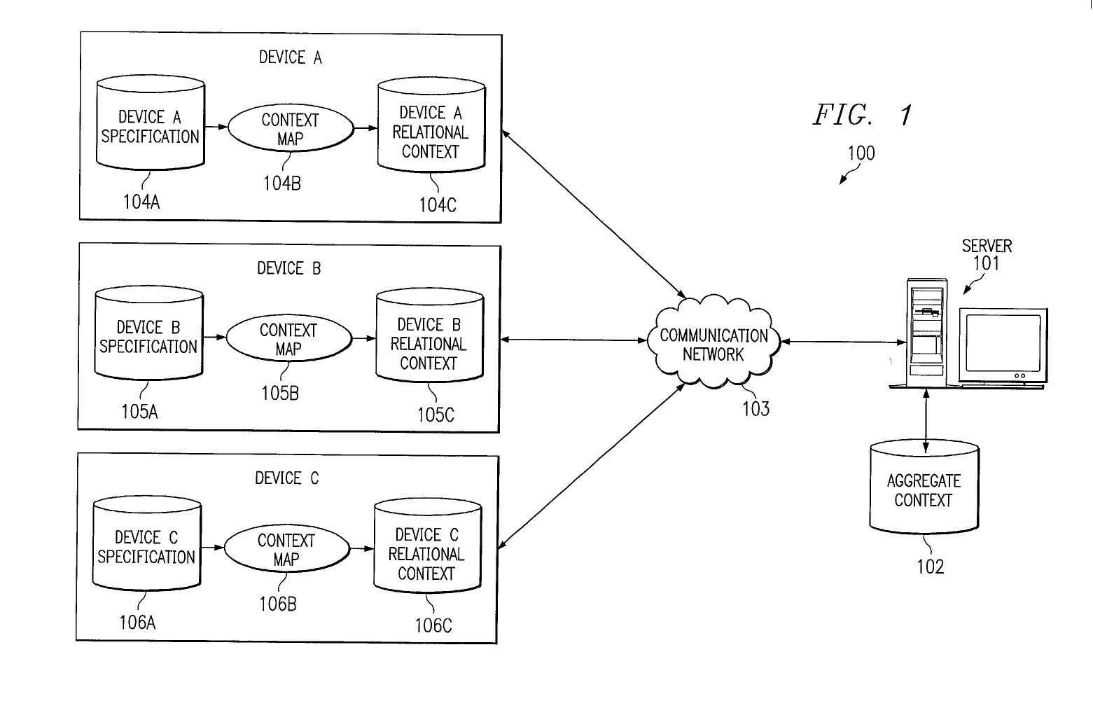

Various embodiments of the present invention are now described with reference to the above Figs., wherein like reference numerals represent like parts throughout the several views. Turning to FIG. 1, an exemplary environment 100 is shown in which various embodiments of the present invention may be implemented. Environment 100 includes server 101, device A, device B, and device C, all of which are communicatively coupled to communication network 103. Communication network 103 may be any type of communication network now known or later discovered, including without limitation a general purpose processor-based information network, PSTN, wireless network, LAN, WAN, modem to modem connection, the Internet, an Intranet, an Extranet, or any combination thereof. Devices A-C may be any type of device that is capable of being communicatively coupled (either directly or indirectly) to communication network 103. Examples of such devices include, but are not limited to, printers, PCs, fax machines, optical scanners, personal digital assistants (PDAs), digital cameras, and data storage devices. Such devices A-C may be coupled directly to communication network 103, or they may be coupled indirectly to such communication network 103 via another device. For example, device C may be communicatively coupled to a processor-based device (e.g., a PC) that is, in turn, coupled to communication network 103. It should be understood that while three devices (i.e., A-C) are shown in the example of FIG. 1, any number of devices may be implemented in the various embodiments of the present invention, and any such implementation is intended to be within the scope of the present invention.

Server 101 may be any suitable processor-based device. Examples of such server 101 include processor-based devices commonly implemented as domain name servers (DNSs) within an Internet environment. As shown, server 101 is capable of accessing aggregate context information 102, which is described in greater detail hereafter. More specifically, aggregate context information 102 may be stored in a data storage device to which server 101 is communicatively coupled. Such data storage device may include any suitable data storage device now known or later discovered for storing data, such as disk drive, floppy disk, random access memory (RAM), optical disc (e.g., Compact Discs (CDs) or Digital Versatile Discs (DVDs)), and other data storage devices, and it may be implemented external or integrated with server 101. Similarly, each of devices A-C may include data storage devices local thereto (e.g., integrated therewith or coupled thereto externally). For instance, device A may include data storage devices for storing device A's operational specification 104A and for storing device A's relational context 104C. Similarly, device B may include data storage devices for storing device B's operational specification 105A and for storing device B's relational context 105C. Likewise, device C may include data storage devices for storing device C's operational specification 106A and for storing device C's relational context 106B. Such data storage devices may be implemented external to their respective devices A-C or may be integrated therein, and the data storage devices may include any suitable device now known or later discovered for storing data, including without limitation disk drives, floppy disks, RAM, optical discs, or other data storage devices. Furthermore, device A's operational specification 104A and device A's relational context 104C may be stored in a common data storage device in certain embodiments of the present invention. Similarly, device B's operational specification 105A and device B's relational context 105C may be stored in a common data storage device in certain embodiments of the present invention. Likewise, operational specification 106A and relational context 106C of device C may be stored in a common data storage device in certain embodiments of the present invention. As described in greater detail hereafter, relational contexts 104C, 105C, and 106C may, for example, specify how the operational capabilities of their respective devices A-C measure up to the operational capabilities of other devices communicatively coupled to communication network 103. For instance, suppose devices A-C are printers. Their individual operational specifications 104A, 105A, and 106A, respectively, may be stored local thereto, which may detail such information as their respective print speed, print resolution, and other operational parameters. The relational contexts 104C, 105C, and 106C, respectively, may detail how the operational capabilities of the respective device A-C relates (e.g., measures up) to other devices coupled to communication network 103. For instance, relational context 104C for device A may specify that it has the fastest print speed available among the printers coupled to communication network 103, while relational context 105C for device B may specify that it has the best print resolution available among such printers.

Additionally, according to at least one embodiment, each of devices A-C includes an application executable thereon for generating/updating the device's relational context based at least in part on aggregate context information 102 received from server 101. For instance, in the example of FIG. 1, devices A-C include mapping applications 104B, 105B, and 106B, respectively, which may be executable to generate/update the respective relational contexts 104C, 105C, and 106C based upon aggregate context information 102 received from server 101 and each device's operational specification 104A, 105A and 106A.

In the operation of at least one embodiment, each of devices A-C communicate their individual operational specification information 104A, 105A, and 106A to server 101. Server 101 has a software application executing thereon to generate aggregate context 102 from the operational specification information received from each of devices A-C. Aggregate context 102 may specify the full range of operational capabilities available from devices A-C, as well as any other devices coupled to communication network 103. That is, aggregate context 102 specifies the aggregate of operational capabilities available on communication network 103. In this manner, aggregate context 102 may be referred to herein as “world” context, as it may specify the operational capabilities available within the “world” of devices communicatively coupled to communication network 103.

It should be understood that in some embodiments, aggregate context 102 may specify the operational capabilities available through all devices coupled to communication network 103 (i.e., the totality of devices coupled to network 103). However, in alternative embodiments, aggregate context 102 may specify information about the operational capabilities of a portion (e.g., a sub-set) of the devices communicatively coupled to communication network 103. For instance, aggregate context 102 may specify information about the operational capabilities of all devices of a particular type (e.g., all printers) that are coupled to network 103, and may not include information about the operational capabilities of other types of devices (e.g., data storage devices) coupled to network 103. Thus, aggregate context 102 may specify the operational capabilities of the aggregate (or totality) of devices of a particular type coupled to network 103. Server 101 communicates information from aggregate context 102 to each of devices A-C, from which mapping applications 104B, 105B, and 106C can determine relational contexts 104C, 105C, and 106C based on each device's respective operational specification 104A, 105A, and 106A. Accordingly, each device A-C is thereby provided with intelligence as to the relationship of its operational capabilities to the operational capabilities of other devices of communication network 103. For instance, each device A-C may have intelligence as to how its operational capabilities measure up to the operational capabilities of other devices of communication network 103.

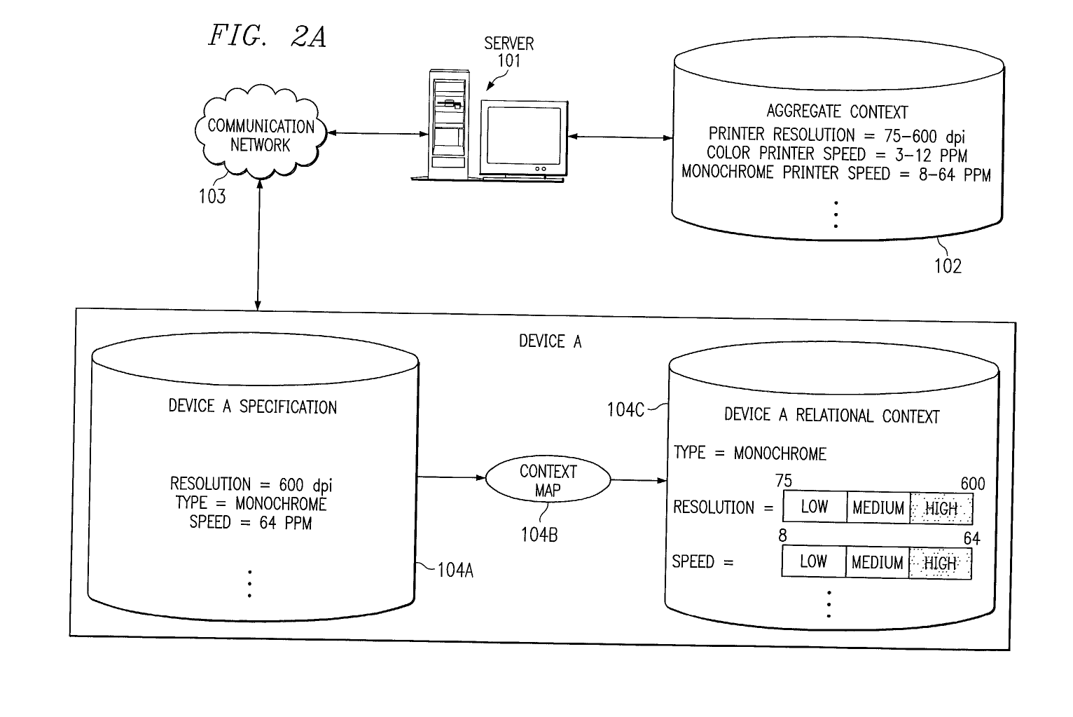

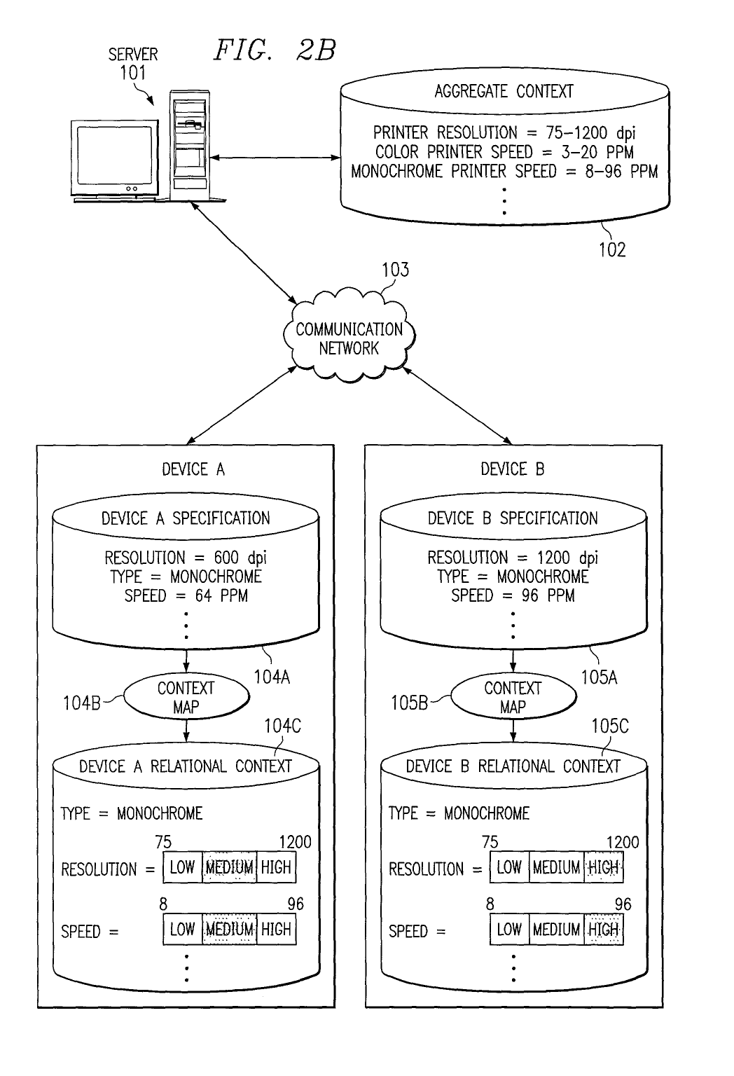

Turning now to FIGS. 2A-2B, an example is shown wherein devices A and B are printers. Accordingly, device A's operational specification 104A details information for various operational parameters of device A, such as print resolution, printer type, print speed, etcetera. In the example of FIG. 2A, device A is coupled to communication network 103, while device B is not yet so coupled. Although, other printers (not shown) are coupled to communication network 103 in the example of FIG. 2A. As detailed in its operational specification 104A, device A has a print resolution of 600 dots per inch (dpi), is a monochrome type printer, and has print speed of 64 pages per minute (PPM). Once device A is coupled to communication network 103, it communicates its operational specification 104A to server 101. A software application executes on server 101 to generate/update aggregate context 102. For instance, in the example of FIG. 2A, aggregate context 102 details that printers are available via communication network 103 that provide various operational capabilities. More specifically, in this example, printers are available via communication network 103 to provide printer resolutions within the range of 75-600 dpi. Additionally, color printers are available via communication network 103 to provide print speeds within the range of 3-12 PPM, and monochrome printers are available via communication network 103 to provide print speeds within the range of 8-64 PPM.

Server 101 may communicate aggregate context information 102 to device A, and mapping application 104B executes on device A to generate relational context 104C utilizing the received aggregate context information and operational specification information 104A. In the example of FIG. 2A, the received aggregate context information specifies that print resolutions ranging from 75-600 dpi are available from printers coupled to communication network 103. Context mapping application 104B may map device A's print resolution, as detailed in its operational specification 104A, onto the received aggregate context to result in relational context 104C for such print resolution parameter of device A. For instance, context mapping application 104B maps the 600 dpi resolution of device A onto the received aggregate context for print resolution, which is the range of 75-600 dpi. Accordingly, from relational context 104C, device A knows that it provides the highest print resolution available via communication network 103. As the example of FIG. 2A further shows, in some embodiments context mapping application 104B may map the received aggregate context information onto relational categories (e.g., low, medium, and high), and may further map device A's operational parameters (e.g., as detailed by its operational specification 104A) onto the proper relational category. In certain embodiments, server 101 may execute to generate such relational categories (e.g., and may be implemented within aggregate context 102), which may be communicated to device A, and context mapping application 104B may map device A's operational parameters onto the received relational categories.

Various other parameters of device A may be mapped onto the received aggregate context in a similar manner. For instance, context mapping application 104B maps the 64 PPM print speed of device A onto the received aggregate context for monochrome printer print speed, which is the range of 8-64 PPM. Accordingly, from relational context 104C, device A knows that it provides the highest print speed available via communication network 103 for monochrome printers. Therefore, in some embodiments, context mapping application 104B may map the print speed for device A onto relational category “high.”

Turning now to FIG. 2B, an example is shown illustrating how aggregate context 102 and relational context 104C of device A may change over time because of the dynamic nature of communication network 103. FIG. 2B shows an example of the environment of FIG. 2A at a later time (e.g., a year later), in which the topology of devices coupled to network 103 has changed. In the example of FIG. 2B, device B is newly added to communication network 103. Device B is a monochrome type printer having a print resolution of 1200 dpi and a print speed of 96 PPM, as detailed in its operational specification 105A. Once device B is coupled to communication network 103, it communicates its operational specification 105A to server 101. This may be through a “broadcast and wait for response” or other suitable technique. For instance, device B may announce its presence on the network and then wait for a response from server 101. Once device B receives a response from server 101, it knows where to communicate it's operational specifications (i.e., to the responding server 101). A software application executes on server 101 to update aggregate context 102. For instance, in the example of FIG. 2B, aggregate context 102 is updated to reflect that printers are now available via communication network 103 to provide printer resolutions within the range of 75-1200 dpi. Additionally, aggregate context 102 is updated to reflect that monochrome printers are available via communication network 103 to provide print speeds within the range of 8-96 PPM. Furthermore, in this example, color printers have been added/upgraded on communication network 103, and aggregate context 102 has been updated accordingly to reflect that color printers are available via communication network 103 to provide print speeds within the range of 3-20 PPM.

Server 101 may communicate at least a portion of aggregate context information 102 to device B, and mapping application 105B executes on device B to generate relational context 105C utilizing the received aggregate context information and operational specification information 105A. In the example of FIG. 2B, the received aggregate context information specifies that print resolutions ranging from 75-1200 dpi are available from printers coupled to communication network 103. Context mapping application 105B may map device B's print resolution, as detailed in its operational specification 105A, onto the received aggregate context to result in relational context 105C for such print resolution parameter of device B. For instance, context mapping application 105B maps the 1200 dpi resolution of device B onto the received aggregate context for print resolution, which is the range of 75-1200 dpi. Accordingly, from relational context 105C, device B knows that it provides the highest print resolution available via communication network 103. As explained above, the context information (of relational context 105C, as well as aggregate context 102) may be divided into relational categories (e.g., low, medium, and high), and context mapping application 105B may map device B's operational parameters (e.g., as detailed by its operational specification 105A) onto the proper relational category, which in the example of FIG. 2B is “high.”

Various other operational parameters of device B may be mapped onto the received aggregate context in a similar manner. For instance, context mapping application 105B maps the 96 PPM print speed of device B onto the received aggregate context for monochrome printer print speed, which is the range of 8-96 PPM. Accordingly, from relational context 105C, device B knows that it provides the highest print speed available via communication network 103 for monochrome printers. Therefore, in some embodiments, context mapping application 105B may map the print speed for device B onto relational category “high,” as shown in the example of FIG. 2B.

Additionally, according to certain embodiments, the devices periodically poll server 101 for updated aggregate context information. Thus, device A may poll server 101 for updated aggregate context information 102 after device B has been added to communication network 103, and server 101 may determine that it has updated aggregate context information to provide to device A. Server 101 may therefore communicate at least a portion of aggregate context information 102 to device A, and mapping application 104B executes on device A to update relational context 104C utilizing the received aggregate context information and operational specification information 104A. In the example of FIG. 2B, the received aggregate context information specifies that print resolutions ranging from 75-1200 dpi are now available from printers coupled to communication network 103. Context mapping application 104B may map device A's print resolution, as detailed in its operational specification 104A, onto the received aggregate context to update the relational context 104C for such print resolution parameter of device A. For instance, context mapping application 104B maps the 600 dpi resolution of device A onto the received aggregate context for print resolution, which is the range of 75-1200 dpi. Accordingly, from relational context 104C, device A knows that it no longer provides the highest print resolution available via communication network 103. As the example of FIG. 2B further shows, in some embodiments context mapping application 104B may map device A's operational parameters (e.g., as detailed by its operational specification 104A) onto the proper relational category, e.g., “medium” in this example. Context mapping application 104B may further map the 64 PPM print speed of device A onto the received aggregate context for monochrome printer print speed, which is the range of 8-96 PPM. Accordingly, from relational context 104C, device A knows that it no longer provides the highest print speed available via communication network 103 for monochrome printers. Therefore, in some embodiments, context mapping application 104B may map the print speed for device A onto relational category “medium,” as shown in the example of FIG. 2B.

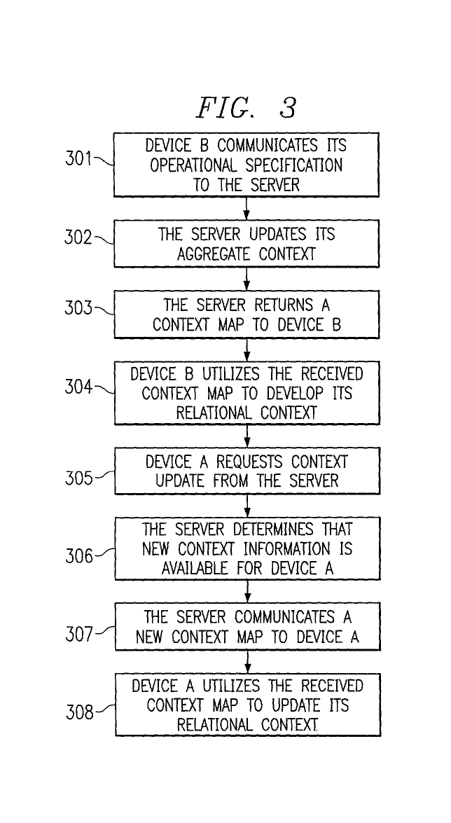

Turning to FIG. 3, an exemplary operational flow diagram of one embodiment is provided, which shows the operational flow for maintaining relational contexts for devices A and B as device B is added (such as in FIG. 2B). In operational block 301, once device B is coupled to communication network 103, it communicates its operational specification 105A to server 101 via broadcast and wait or other suitable technique as previously described. Server 101 then, in block 302, updates its aggregate context 102 to reflect the addition of the operational capabilities provided by device B. That is, software executes on server 101 to update aggregate context 102 to reflect the operational parameters now available via device B. Aggregate context 102 may be arranged in any suitable manner, including as examples a database, data structure, table, flat file, or any other suitable arrangement of information. For instance, in one implementation, aggregate context 102 may be arranged as a database that includes information about operational capabilities of different devices coupled to communication network 103. Additionally, aggregate context 102 may comprise a plurality of databases (or other arrangements), wherein each database comprises information for particular types of devices coupled to communication network 103. For example, one database may be included in which aggregate context information for all printers coupled to communication network 103 is stored, and another database may be included in which aggregate context information for all data storage devices coupled to communication network 103 is stored.

Furthermore, aggregate context 102 may be mirrored in various locations, and a plurality of different servers 101 may be provided which are each capable of accessing an associated aggregate context 102. For example, a first server 101 and associated aggregate context 102 may be arranged in the United States, and a second server 101 and associated aggregate context 102 (having mirrored information) may be arranged in France. In this manner, the distance/cost of communication of operational specifications from devices to a server and communication of aggregate context information from a server to devices may be minimized, as such information may be communicated to/from the nearest server 101 to such devices. Also, information of aggregate context 102 may be formatted in any suitable manner, including as examples extensible markup language (XML) format, hypertext markup language (HTML), American Standard Code for Information Interchange (ASCII) format, binary format, or any other suitable format now known or later discovered.

In block 303, server 101 communicates at least a portion of aggregate context 102 to device B. In some embodiments, server 101 may communicate relevant portions of such aggregate context 102 to device B, as opposed to the entire aggregate context 102. For instance, assuming that device B is a printer, then in certain embodiments, server 101 may communicate information from aggregate context 102 that is relevant to printers (e.g., print speed, resolution, etc.), while omitting non-relevant information (e.g., information that may be relevant to data storage devices). In other embodiments, server 101 may communicate all of aggregate context 102 to device B, and device B may determine the appropriate information (e.g., parameters) to be included in relational context 105C. For instance, device B may execute application software to filter the parameters of aggregate context 102 against the parameters of operational specification 105A to determine the relevant parameters to be included in relational context 105C.

In block 304, device B executes context mapping application 105B to generate relational context 105C utilizing the received aggregate context information and device B's operational specification 105A. As described above with aggregate context information 102, relational context information 105C may be arranged in any suitable manner including as examples a database, data structure, table, flat file, or any other suitable arrangement of information. Additionally, information of relational context 105C may be formatted in any suitable manner, including as examples XML format, HTML, ASCII format, binary format, or any other suitable format now known or later discovered.

In block 305, device A polls server 101 (e.g., according to a defined interval, such as once an hour, once a day, once a week, etc., to query whether updated aggregate context information exists, and in block 306 server 101 determines that updated aggregate context information is available for device A. In certain embodiments, server 101 may determine whether updated aggregate context information 102 that is relevant to device A is available. For example, assuming device A is a printer, server 101 may determine whether updated aggregate context information 102 that is relevant to printers (e.g., printer speed, print resolution, etc.) is available. Thus, in certain embodiments, updating of aggregate context information 102 for other types of devices, such as data storage devices, does not result in communication of updated aggregate context information 102 to printers, as such context information may be irrelevant to printers.

In block 307, server 101 communicates at least a portion of the updated aggregate context 102 to device A. As described above with device B, in some embodiments, server 101 may communicate relevant portions of such aggregate context 102 to device A, as opposed to the entire aggregate context 102. For instance, assuming that device A is a printer, then in certain embodiments, server 101 may communicate information from aggregate context 102 that is relevant to printers (e.g., print speed, resolution, etc.), while omitting non-relevant information (e.g., information that may be relevant to data storage devices). In other embodiments, server 101 may communicate all of aggregate context 102 to device A, and device A may determine the appropriate information (e.g., parameters) to be included in relational context 104C. For instance, device A may execute application software to filter the parameters of aggregate context 102 against the parameters of operational specification 104A to determine the relevant parameters to be included in relational context 104C. In block 308, device A executes context mapping application 104B to update its relational context 104C utilizing the received aggregate context 102 and device A's operational specification 104A. As described above with relational context 105C of device B, information of relational context 104C of device A may be arranged in any suitable manner, such as a database, and such information may be formatted in any suitable manner, such as XML format.

While the above example describes an embodiment in which devices periodically poll server 101 for updated aggregate context information 102, such updated context information may be communicated to devices in various other manners in alternative embodiments, in addition to or instead of such polling. For instance, in certain embodiments, server 101 may communicate updated aggregate context information 102 to the appropriate network devices upon a change occurring within such aggregate context information 102. Preferably, a scheme is implemented for communicating updated aggregate context information 102 to the appropriate network devices in a manner that does not negatively impact communication network 103. For instance, devices may be implemented to poll server 101 for updated aggregate context information at differing times so that a large spike of communication traffic to server 101 from various devices and from server 101 to various devices is not encountered. Alternatively, devices may be implemented to poll server 101 for updated aggregate context information at times known to have low traffic across communication network 103, thereby reducing the impact that the communication traffic created by such polling has on communication network 103. As another example, server 101 may be implemented to communicate changes to aggregate context information 102 to the appropriate network devices one at a time (or a few at a time), as opposed to communicating such changes to all devices at once, so as to provide a relatively even distribution of the traffic across communication network 103. Alternatively (or additionally) server 101 may be implemented to communicate changes to aggregate context information 102 to the appropriate network devices during known times of low network traffic.

Similar to adding a new device (as described in the example above), an upgrade of an existing device's operational capabilities may result in updating of aggregate context information 102 and the individual relational contexts of appropriate devices, if necessary. For example, suppose that device A of FIG. 2B is upgraded to provide print resolution of 1250 dpi. Such updated operational parameter would be communicated to server 101, which would update aggregate context 102 to reflect this operational capability. Thereafter, at least a portion of aggregate context 102 would be communicated to the printers coupled to communication network 103, which will each generate updated relational context information.

It should be recognized that various embodiments of the present invention enable devices to be easily queried by an application or user from server 101 or another device communicatively coupled to communication network 103. For example, in at least one embodiment, devices have their operational parameters mapped to particular relational categories (e.g., low, medium, or high) of the aggregate context 102, which may enable a user/application to query devices utilizing such relational categories. For instance, in the above examples, printers may be easily queried by an application or user in that an application or user may query devices based on the specific relational categories for different operational parameters. For example, an application may request identification of printers that have “print resolution=high” and also have “print speed=>medium.” Such a query may be sent to all printers coupled to communication network 103, and only those printers that have print resolution of high and also have print speed equal to or greater than “medium” will respond to such query. Thus, various embodiments allow requests to be made by an application or a user in a more easily understandable manner. For instance, an application or user may query for the printer having the “best” (or “highest”) print resolution, without being required to make a request based on actual parameter values, such as 1200 dpi resolution.

Additionally, various embodiments may reduce network traffic required for identifying appropriate device(s) that satisfy particular operational parameters, as only those devices fitting the specified operational criteria will respond to a user/application. For instance, rather than an application being required to query each printer for its print resolution and the application receiving such print resolution parameter from each device so that the application can identify the printer having the best resolution, the application may instead send a query for “best” resolution, and only those printers that know they fit this criteria need respond. Accordingly, network traffic may be reduced, as every device need not respond to every query.

Also, various embodiments may reduce the amount of processing required by a requesting application for identifying such appropriate device(s). For instance, rather than an application being required to filter through print resolutions received from all printers coupled to the communication network to determine the printer having the best resolution, the application may query the printers for those that have the best resolution and the appropriate printers satisfying such criteria will respond, thereby reducing the processing required by the application in identifying the appropriate device.

Also, various embodiments of the present invention enable software applications to be developed in a manner such that they automatically adapt and effectively utilize enhancements in operational parameters as they become available via the communication network. For instance, an application may be developed that specifies that it is to print certain information to the monochrome printer having the “best” print resolution, and such application may automatically print to different printers that satisfy such “best” resolution criteria as new printers are added and/or existing printers are upgraded over time. Therefore, an application may dynamically make use of technological advancements as they become available on the communication network.

It should be understood that while specific examples of information that may be included within aggregate context information 102 and relational context information 104C, 105C have been provided herein, various other information may be included. Additionally, such information may be arranged in any suitable manner. For instance, in various examples above, aggregate context information 102 includes ranges of operational parameters provided by devices coupled to communication network 103 (e.g., range of printer speed, range of printer resolution, etc.). Rather than such ranges (or in addition to such ranges), aggregate context 102 may, in some embodiments, include specific values for operational parameters that are available via communication network 103. For example, aggregate context 102 may include “monochrome printer speed: 8 PPM, 24 PPM, 32 PPM, 64 PPM, and 96 PPM,” as opposed to the range of “8-96 PPM,” to specifically identify each operational parameter value available via network 103. Additionally, in some embodiments, aggregate context 102 is not limited to those parameters provided in the operational specification of devices, but may also include parameters which may be derived by server 101. For instance, operational specifications of printers may include print speed and print resolution parameters, and server 101 may derive a parameter within aggregate context 102 for “combined print speed and print resolution.” Similarly, mapping application software executing on a device may be capable of mapping a plurality of parameters from the device's operational specification onto the derived parameter. Thus, for instance, a single derived parameter may effectively rate a printer's “combined print speed and print resolution” as “low, medium, or high.”

It should also be understood that while “low, medium, and high” are used as relational categories in the above examples, various other types of relational categories may be implemented in certain embodiments. That is, any suitable relational category (in addition to or instead of) the “low, medium, and high” categories may be implemented in various embodiments, and any such implementation is intended to be within the scope of the present invention. Further, in certain embodiments, any of such relational categories that are implemented may be used by a user and/or application to search for a network device having desired operational parameters. One example of a further relational category that may be implemented is a “Publishing Quality Printers” category, which may, for example, include printers that have at least 600 dpi resolution, color capability, laser capability, photo enhancement technology, finishing capability (e.g., folding, laminating, etc), and at least 6 PPM print speed. Of course, this category may change over time as publishing capabilities of printers increase. That is, as operational parameters provided by printers available on the network change, the criteria for being categorized as a “Publishing Quality Printer” may change.

Furthermore, it should be understood that according to at least one embodiment of the present invention, existing devices (e.g., existing printers, data storage devices, processing devices, etc.) may be adapted to include such relational context intelligence relatively easily. For instance, the context mapping application may be implemented on an existing device to receive aggregate context information and generate relational context information for the device based on the device's operational specification information. Also, while various examples provided herein use printers as devices coupled to communication network 103, the present invention is not intended to be limited solely to printers, but is instead intended to encompass any other type of device that may be communicatively coupled (either directly or indirectly) to communication network 103.

Also, various operational parameters other than (or in addition to) those provided in the examples herein may be included in aggregate context information 102 and/or relational contexts of devices. As examples, a parameter may include a particular time of day in which it is preferable to use a particular device (e.g., may provide a time of day ranking), a parameter may specify the amount of available storage on a device (e.g., within a data storage device coupled to communication network 103), and a parameter may specify the amount of processing power of a device (e.g., the number of CPUs provided by a device). For instance, if an application needs to perform multi-tasking, it may query the processing devices available on communication network 103 to identify a processing device having an appropriate number of CPUs (e.g., high number of CPUs), which each operate at the fastest speed. Alternatively, such a query may simply ask for the processing device available on communication network 103 which provides the greatest total processing power (considering the sum of all CPUs provided by each device), and assuming that such a parameter of “total processing power” is maintained within the processing devices' relational contexts, the most appropriate device may be easily and quickly identified.

What is claimed is:

1. A system comprising:
server communicatively coupled to a communication network;
aggregate context information specifying operational parameters available via said communication network, wherein said aggregate context information is communicatively accessible by said server; and
at least one device communicatively coupled to said communication network, wherein said at least one device includes operational specification information specifying individual operational parameters of said at least one device stored locally to said at least one device, and wherein said at least one device further includes relational context information stored locally thereto specifying the relation of said individual operational parameters of said at least one device to said aggregate of operational parameters available via said communication network.

2. The system of claim 1 wherein said communication network is a network selected from the group consisting of: general purpose processor-based information network, PSTN, wireless network, LAN, WAN, modem to modem connection, the Internet, an Intranet, an Extranet, and any combination thereof.

3. The system of claim 1 wherein said aggregate context information includes information specifying an aggregate of operational parameters available via a totality of devices communicatively coupled to said communication network.

4. The system of claim 1 wherein said aggregate context information includes information specifying an aggregate of operational parameters available via a totality of devices of a particular type communicatively coupled to said communication network.

5. The system of claim 1 wherein said aggregate context information includes information specifying one or more ranges of operational parameters available via devices coupled to said communication network.

6. The system of claim 1 wherein said at least one device is selected from the group consisting of: printers, processor-based devices, data storage devices, fax machines, optical scanners, PDAs, digital camers, and any peripheral device capable of being communicatively coupled, either directly or indirectly, to said communication network.

7. The system of claim 1 wherein said relational context information includes information comparing one or more of said individual operational parameters of said at least one device to like operational parameters of other devices coupled to said communication network.

8. The system of claim 1 wherein said at least one device includes a software application executable thereon to receive at least a portion of said aggregate context information and map one or more of said individual operational parameters of said at least one device onto the received aggregate context information to generate said relational context information.

9. The system of claim 1 wherein said server includes a software application executable thereon to map said aggregate context information into relational categories.

10. The system of claim 9 wherein said relational categories includes different categories for different values of an operational parameter.

11. The system of claim 1 wherein said at least one device includes a software application executable thereon to map one or more of said individual operational parameters of said at least one device onto proper relational categories of said aggregate context information.

12. The system of claim 11 wherein said software application is executable to respond to a received query as to whether one or more of said operational parameters of said at least one device are within a particular relational category of said aggregate context information.

13. The system of claim 1 wherein said at least one device includes a software application executable thereon to communicate said operational specification information to said server, and wherein said server includes a software application executable thereon to receive said operational specification information and update said aggregate context information to reflect said operational specification information.

14. A device communicatively connectable to a communication network, said device comprising:
operational specification information stored locally thereto, wherein said operational specification information includes information specifying individual operational parameters of said device;
means for receiving aggregate context information specifying an aggregate of operational parameters available via said communication network; and
means for mapping at least a portion of said operational specification information onto the received aggregate context information to generate relational context information specifying the relation of said individual operational parameters of said device to said aggregate of operational parameters available via said communication network.

15. The device of claim 14 wherein said means for receiving and said means for mapping comprise a software application executable on said device.

16. The device of claim 14 wherein said relational context information is stored locally to said device.

17. The device of claim 14 wherein said aggregate context information includes information specifying an aggregate of operational parameters available via a totality of devices of at least one type communicatively coupled to said communication network.

18. The device of claim 14 wherein said aggregate context information includes information specifying one or more ranges of operational parameters available via devices coupled to said communication network.

19. The device of claim 14 wherein said relational context information includes information comparing one or more of said individual operational parameters to like operational parameters of other devices coupled to said communication network.

20. A method for providing relational context intelligence to a network device, said method comprising the steps of:
communicatively coupling a server to a communication network;
communicatively coupling a first network device to said communication network;
receiving at said server from said first network device operational specification information specifying individual operational parameters of said first network device;
updating aggregate context information at said server to reflect the received operational specification information, wherein said aggregate context information specifies an aggregate of operational parameters available via said communication network;
communicating at least a portion of said aggregate context information to said first network device;
said first network device generating relational context information specifying a relation of said first network device's operational parameters to operational parameters of other network devices communicatively coupled to said communication network; and
storing said relational context local to said first network device.

21. The method of claim 20 wherein said generating relational context information further comprises:
said first network device mapping at least a portion of operational parameters available from said operational specification information of said first network device onto the received aggregate context information to generate said relational context information.

22. The method of claim 20 wherein said aggregate context information includes information specifying an aggregate of operational parameters available via a totality of devices communicatively coupled to said communication network.

23. The method of claim 20 wherein said aggregate context information includes information specifying an aggregate of operational parameters available via a totality of devices of a particular type communicatively coupled to said communication network.

24. The method of claim 20 wherein said relational context information includes information comparing one or more of said individual operational parameters of said first network device to like operational parameters of other devices coupled to said communication network.

25. The method of claim 20 further comprising:
said server mapping said aggregate context information into relational categories.

26. The method of claim 25 further comprising:
said first network device mapping one or more of said individual operational parameters of said first network device onto proper relational categories of said aggregate context information.

27. The method of claim 26 further comprising:
said first network device responding to a received query as to whether one or more of said operational parameters of said first network device are within a particular relational category.

28. The method of claim 20 further comprising the steps of:
communicatively coupling a second network device to said communication network;
receiving at said server from said second network device operational specification information specifying individual operational parameters of said second network device;
updating said aggregate context information at said server to reflect the received operational specification information received from said second network device;
communicating at least a portion of the updated aggregate context information to said second network device;
said second network device generating relational context information specifying a relation of said second network device's operational parameters to operational parameters of other network devices communicatively coupled to said communication network; and
storing said relational context local to said second network device.

29. The method of claim 28 further comprising the steps of:
said server communicating the updated aggregate context information to said first network device; and
said first network device re-generating relational context information specifying a relation of said first network device's operational parameters to operational parameters of other network devices communicatively coupled to said communication network.

30. The method of claim 29 wherein said re-generating relational context information further comprises:
said first network device mapping at least a portion of operational parameters available from said operational specification information of said first network device onto the received updated aggregate context information to generate said relational context information.

31. A device communicatively connectable to a communication network, said device comprising:
operational specification information stored locally thereto, wherein said operational specification information includes information specifying individual operational parameters of said device;
wherein said device is configured to receive aggregate context information specifying an aggregate of operational parameters available via said communication network; and
wherein said device is configured to map at least a portion of said operational specification information onto the received aggregate context information to generate relational context information specifying the relation of said individual operational parameters of said device to said aggregate of operational parameters available via said communication network.

32. The device of claim 31 further comprising:
software stored locally to said device that is executable by said device to receive said aggregate context information and to map said at least a portion of said operational specification information onto the received aggregate context information to generate said relational context information.

33. The device of claim 31 wherein said relational context information is stored locally to said device.

34. The device of claim 31 wherein said aggregate context information includes information specifying an aggregate of operational parameters available via a totality of devices of at least one type communicatively coupled to said communication network.

35. The device of claim 31 wherein said aggregate context information includes information specifying one or more ranges of operational parameters available via devices coupled to said communication network.

36. The device of claim 31 wherein said relational context information includes information comparing one or more of said individual operational parameters to like operational parameters of other devices coupled to said communication network.

37. A computer program product for providing relational context intelligence to a device communicatively connectable to a communication network, said computer program product comprising a computer-readable storage medium having computer-readable program code embodied in said medium, said computer readable program code comprising:
code executable to receive aggregate context information specifying an aggregate of operational parameters available via said communication network; and
code executable to map at least a portion of operational specification information for said device onto the received aggregate context information to generate relational context information, wherein said operational specification information includes information specifying individual operational parameters of said device and wherein said relational context information includes information specifying the relation of said individual operational parameters of said device to said aggregate of operational parameters available via said communication network.

38. The computer program product of claim 37 wherein said device comprises said computer-readable storage medium local thereto, and wherein said device includes a processor for executing said computer readable program code.

39. The computer program product of claim 37 wherein said computer readable program code further comprises:
code executable to store said relational context information locally to said device.

40. The computer program product of claim 37 wherein said aggregate context information includes information specifying an aggregate of operational parameters available via a totality of devices of at least one type communicatively coupled to said communication network.

41. The computer program product of claim 37 wherein said aggregate context information includes information specifying one or more ranges of operational parameters available via devices coupled to said communication network.

42. The computer program product of claim 37 wherein said relational context information includes information comparing one or more of said individual operational parameters to like operational parameters of other devices coupled to said communication network.

43. The computer program product of claim 37 wherein said device is selected from the group consisting of: printers, processor-based devices, data storage devices, fax machines, optical scanners, PDAs, digital camers, and any peripheral device capable of being communicatively coupled, either directly or indirectly, to said communication network.

44. The computer program product of claim 37 wherein said aggregate context information is arranged into relational categories, and wherein said computer readable program code further comprises:
code executable to map one or more of said individual operational parameters of said device onto proper relational categories of said aggregate context information.

43. The computer program product of claim 44 wherein said computer readable program code further comprises:
code executable to respond to a received query as to whether one or more of said operational parameters of said device are within a particular relational category of said aggregate context information.

44. The computer program product of claim 37 wherein said computer readable program code further comprises:
code executable to communicate said operational specification information to a server via said communication network.

45. The computer program product of claim 44 wherein said code executable to receive said aggregate context information is executable to receive said aggregate context information from said server via said communication network
